(19) United States
(12) Patent Application Publication
(10) Pub. No.: US 2019/0286562 A1
(43) Pub. Date: Sep. 19, 2019

(54) INFORMATION PROCESSING APPARATUS, CACHE CONTROL APPARATUS AND CACHE CONTROL METHOD

(71) Applicants: KABUSHIKI KAISHA TOSHIBA, Minato-ku (JP); Toshiba Electronic Devices & Storage Corporation, Minato-ku (JP)

(72) Inventor: Nobuaki SAKAMOTO, Kawasaki (JP)

(73) Assignees: KABUSHIKI KAISHA TOSHIBA, Minato-ku (JP); Toshiba Electronic Devices & Storage Corporation, Minato-ku (JP)

(21) Appl. No.: 16/114,500

(22) Filed: Aug. 28, 2018

(30) Foreign Application Priority Data
Mar. 19, 2018 (JP) 2018-051258

(51) Int. Cl. G06F 12/0831; G06F 12/0842; G06F 12/0868

(52) U.S. Cl. CPC G06F 12/0835; G06F 12/0891; G06F 12/0868; G06F 12/0842

(57) ABSTRACT

According to an embodiment, an information processing apparatus includes a cache memory and a cache controller. The cache controller includes a first circuit, a second circuit and a third circuit. The first control circuit is configured to store a designated address range for a process of cache maintenance. The second circuit is configured to determine whether or not the addresses to be accessed for the cache memory by the information processing apparatus are within the designated address range. The third circuit is configured to store reservation information for reserving execution of a process of cache maintenance for cache lines corresponding to addresses within the designated address range.

### CROSS-REFERENCE TO RELATED APPLICATIONS

This application is based upon and claims the benefit of priority from the Japanese Patent Application No. 2018-051258, filed Mar. 19, 2018, the entire contents of which are incorporated herein by reference.

### FIELD

Embodiments described herein relate generally to an information processing apparatus, a cache control apparatus, and a cache control method.

### BACKGROUND

In computers, cache memories caching data to be accessed are used to speed up data access.

Such cache memories require, for example, a process of invalidating cached data (cache lines) to maintain coherence between the processor (CPU) and another master. A write back cache method requires a process of flushing cache lines to the main memory. These processes are collectively referred to as process of cache maintenance.

According to the conventional process of cache maintenance, whether or not an address read out from a tag memory matches a designated address range is determined, and if the address matches, the valid bit is cleared. The process is then repeated for the designated address range. Thus, when the process of cache maintenance is executed for a designated address range, and the designated address range is wide, both the execution time and the power consumption needed for the process of cache maintenance increase as a result of repeating the process. Hence, the process of cache maintenance for a designated address range must be speeded up and the power consumption must be lowered.

### BRIEF DESCRIPTION OF THE DRAWINGS

FIG. 1 is a block diagram showing a configuration of an information processing apparatus according to an embodiment;

FIG. 2 is a block diagram showing a configuration of a cache memory unit according to the embodiment;

FIG. 3 is a block diagram showing a configuration of a cache controller according to the embodiment;

FIG. 4 is a diagram explaining correspondence between data arrays and tag addresses according to the embodiment;

FIG. 5 is a flowchart explaining a process flow of a CPU and a cache controller according to the embodiment;

FIG. 6 is a diagram explaining an example of the process of a cache control according to the embodiment;

FIG. 7 is a diagram explaining an example of the process of a cache control according to the embodiment;

FIG. 8 is a diagram explaining an example of the process of a cache control according to the embodiment;

FIG. 9 is a diagram explaining an example of the process of a cache control according to the embodiment;

FIG. 10 is a diagram explaining an example of the process of a cache control according to the embodiment.

### DETAILED DESCRIPTION

According to an embodiment, an information processing apparatus includes a cache memory and a cache controller. The cache controller includes a first circuit, a second circuit and a third circuit. The first control circuit is configured to store a designated address range for a process of cache maintenance. The second circuit is configured to determine whether or not the addresses to be accessed for the cache memory by the information processing apparatus are within the designated address range. The third circuit is configured to store reservation information for reserving execution of a process of cache maintenance for cache lines corresponding to addresses within the designated address range.

Various embodiments will be described below with reference to the accompanying drawings.

[System Configuration]

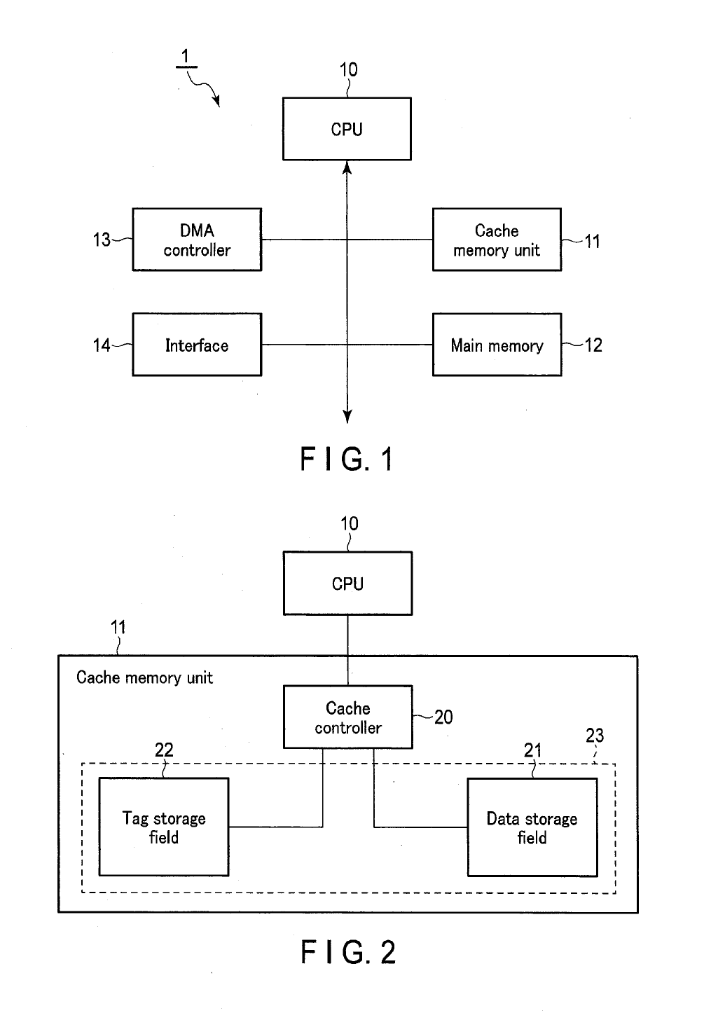

FIG. 1 is a block diagram showing an example configuration of an information processing apparatus (hereinafter, computer) 1 according to the embodiment. As shown in FIG. 1, the computer 1 includes a processor (CPU) 10, a cache memory unit 11, a main memory 12, a direct memory access (DMA) controller 13, and an interface 14.

The CPU 10 accesses, based on predetermined software, the cache memory unit 11 and the main memory 12, and performs information processing such as image processing. As will be described later, the cache memory unit 11 has a cache memory consisting of, for example, a SRAM (Static Random Access Memory). The cache memory includes a tag storage field and a data storage field. According to the embodiment, the cache memory unit 11 is configured to include a cache controller being a main element of the embodiment.

The DMA controller 13 controls memory access that does not involve the CPU 10. The DMA controller 13 executes, for example, via the interface 14, direct data transfer between the main memory 12 and a peripheral device.

FIG. 2 is a block diagram showing an example configuration of the cache memory unit 11. As shown in FIG. 2, the cache memory unit 11 has a cache controller 20 and a cache memory 23. The cache memory 23 includes a data storage field 21 and a tag storage field 22. The cache controller 20 executes, as will be described later, cache control including a process of cache maintenance according to the embodiment. The data storage field 21 is a storage field for storing cache lines (cache data of a predetermined unit). The tag storage field 22 is a storage field for storing cache line addresses (tag addresses) and address histories.

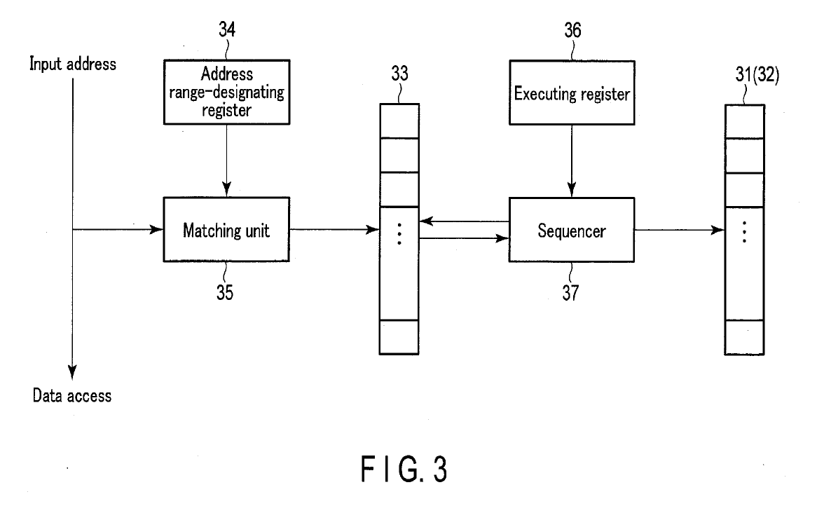

FIG. 3 is a block diagram showing a configuration of the cache controller 20. As shown in FIG. 3, the cache controller 20 has a plurality of data arrays 31-33. These data arrays include a valid bit data array (hereinafter, VB data array) 31, a dirty bit data array (hereinafter, DB data array) 32, and a reserved bit data array (hereinafter, RB data array) 33.

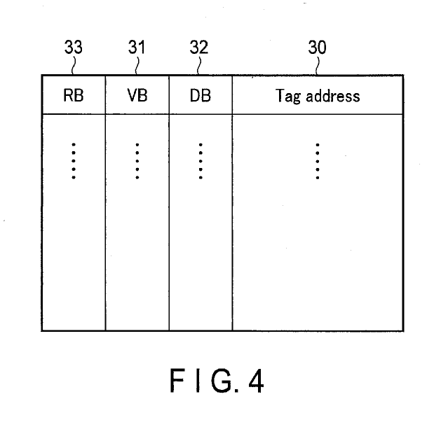

FIG. 4 is a diagram showing correspondence between each of the data arrays 31-33 and a tag address 30 in the tag storage field 22. The tag address 30 is a cache line address and corresponds to the address of the main memory 12. Each of the data arrays 31-33 holds 1 bit of data (flag information) for each cache line.

Here, the process of flushing included in the process of cache maintenance means a process of invalidation and a process of write back. By the process of invalidation and the process of flushing, the valid bit “1” of the corresponding cache lines in the VB data array 31 is cleared to “0”. By the process of flushing, the dirty bit “1” of the corresponding cache lines in the DB data array 32 is cleared to “0”. The RB data array 33 is a data array that reserves execution of a process of cache maintenance (process of invalidation or process of flushing).

Going back to FIG. 3, the cache controller 20 includes an address range-designating register 34, a matching unit 35, an executing register 36, and a sequencer 37. The address range-designating register 34 holds a designated address range for the process of cache maintenance set by the CPU 10. The matching unit 35 determines whether or not input addresses entered at the CPU 10 match the designated address range set in the address range-designating register 34. The input addresses are addresses of data storage field 21 to be accessed by the CPU 10.

The executing register 36 holds flag information prompting execution of the process of invalidation set by the CPU 10. The sequencer 37 clears, according to flag information “1” set in the executing register 36, the valid bit corresponding to the cache lines where the reserved bit is set in the RB data array 33 to “0”. In the case of the write back cache, the dirty bit is cleared to “0”.

[Cache Control]

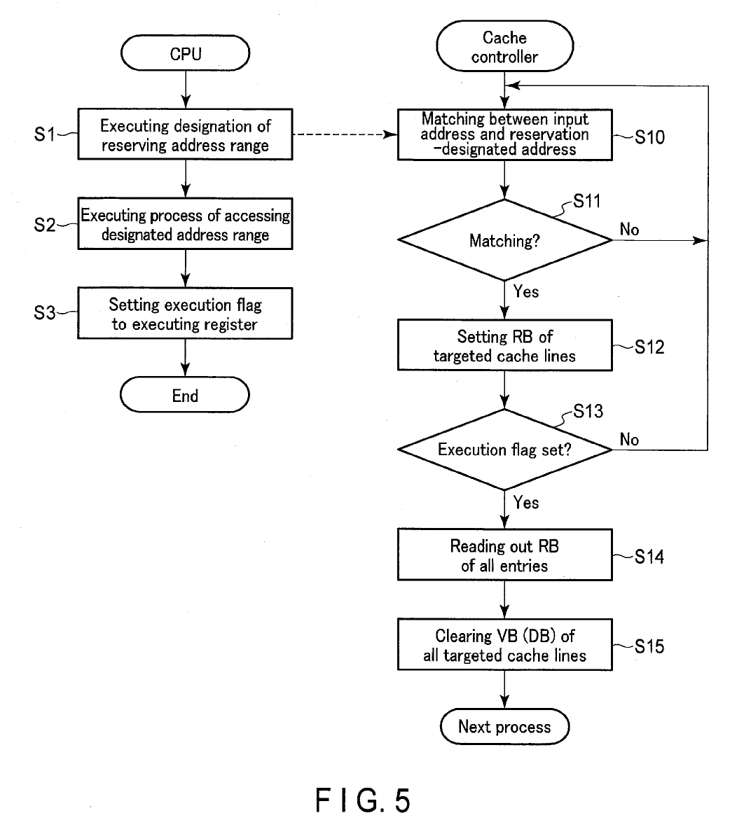

With reference to FIGS. 5-10, the actions of the cache controller 20 according to the embodiment will be described below. FIG. 5 is a flowchart explaining the process flow of the CPU 10 and the cache controller 20.

First, in the computer 1, for example, the CPU 10 processes image data (buffer data) stored inside a frame buffer kept in the main memory 12, and transfers the image data to a display device via the interface 14. Then, when, for example, the DMA controller 13 loads the next buffer data (image data) to the frame buffer, it becomes necessary to execute the process of invalidating the previous unnecessary buffer data (image data) stored in the cache memory unit 11. When this is the case, the process of invalidation is executed for the cache lines corresponding to the address range of the frame buffer.

Note that the same is true for the write back cache and the process of flushing (writing) buffer data written beforehand to the cache memory 11 to the frame buffer saved in the main memory 12. In other words, the process of flushing is executed for the cache lines corresponding to the address range of the frame buffer.

As described above, the process of invalidation and the process of flushing are collectively referred to as the process of cache maintenance. Below, the process of invalidation will be described as actions of the cache controller 20.

As shown in FIG. 5, the CPU 10 executes reservation of the process of invalidating the cache lines corresponding to the designated address range before executing the process of accessing the addresses within the designated address range (S1). More specifically, as shown in FIG. 3, in the address range-designating register 34 of the cache controller 20, the CPU 10 sets the designated address range to be reserved for the process of invalidation. In this case, the CPU 10 treats, as described above, the address range in which the previous buffer data stored in the cache memory unit 11 is stored as the designated address range.

Going back to FIG. 5, the CPU 10 executes the process of accessing the addresses within the designated address range (S2). The cache controller 20 then enters the input addresses to be accessed by the CPU 10 into the matching unit 35, and the matching unit 35 then determines whether or not the input addresses match the designated address range set in the address range-designating register 34 (S10).

The cache controller 20 sets the reserved bits (RB) of the corresponding cache lines in the RB data array 33 (S12), if the matching unit 35 (YES in S11) has determined that the input addresses match the designated address range. In this manner, the reserved bits (RB) of all cache lines in the RB data array 33 corresponding to the input addresses matching the designated address range are set.

The CPU 10 sets, when the process of accessing is completed, flag information “1” prompting the executing register 36 to execute the process of invalidation (S3). In this manner, the cache controller 20 executes the process of invalidation.

More specifically, if flag information “1” is set in the executing register 36 (YES in S13), the sequencer 37 retrieves all entries in the RB data array 33 and reads out the reserved bit (S14). The sequencer 37 then clears the valid bit (VB) of all cache lines for which the reserved bit is set in the VB data array 31 to “0” (S15).

In this manner, all cache lines within the designated address range to be reserved are invalidated. In other words, the unnecessary buffer data (for example, the aforementioned previous buffer data) (image data) stored in the data storage field 21 of the cache memory unit 11 is invalidated.

If the VB data array 31 and the RB data array 33 here are configured of flip-flops, the sequencer 37 is capable of collectively clearing the valid bit (VB) of all cache lines to “0”. However, if the VB data array 31 and the RB data array 33 are configured of a SRAM, the sequencer 37 processes all entries in the RB data array 33 sequentially.

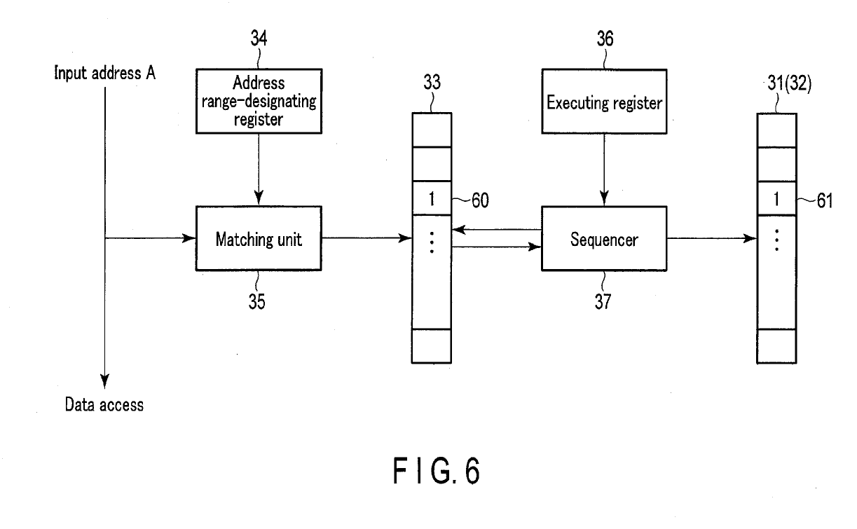

FIGS. 6-10 are diagrams showing variations in the respective bits of the VB data array 31 and the RB data array 33 during the process of invalidation by the cache controller 20 as described above.

First, as shown in FIG. 6, when input address (A) from the CPU 10 matches the designated address range, the corresponding reserved bit (RB) 60 in the RB data array 33 is set to “1”. On the other hand, since the cache line of input address (A) to be accessed by the CPU 10 is entered in the cache memory unit 11, the corresponding valid bit (VB) 61 is set to “1” in the VB data array 31.

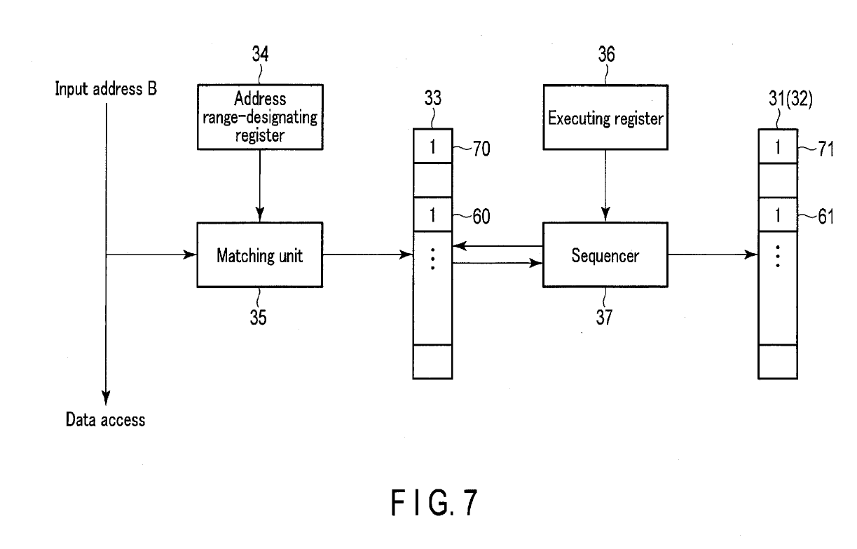

Next, as shown in FIG. 7, when input address (B) from the CPU 10 matches the designated address range, the corresponding reserved bit (RB) 70 in the RB data array 33 is set to “1”. On the other hand, since the cache line of input address (B) to be accessed by the CPU 10 is entered in the cache memory unit 11, the corresponding valid bit (VB) 71 is set to “1” in the VB data array 31.

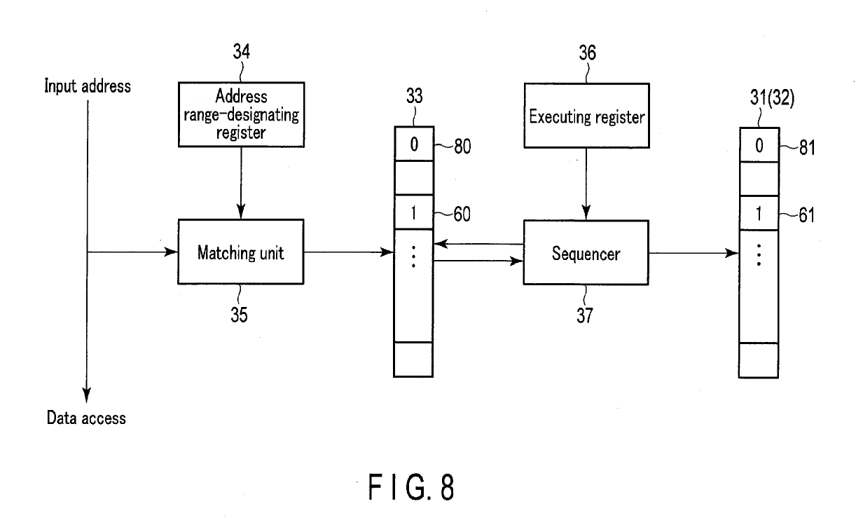

Next, when flag information “1” is set in the executing register 36, the sequencer 37 reads out the set reserved bit (in this case, 70 shown in FIG. 7) from the RB data array 33. As shown in FIG. 8, the sequencer 37 clears the valid bit (VB) 81 of the cache line corresponding to the reserved bit in the VB data array 31 to “0”. After the process of invalidating the cache lines, the sequencer 37 clears the corresponding reserved bit (RB) 80 in the RB data array 33 to “0”.

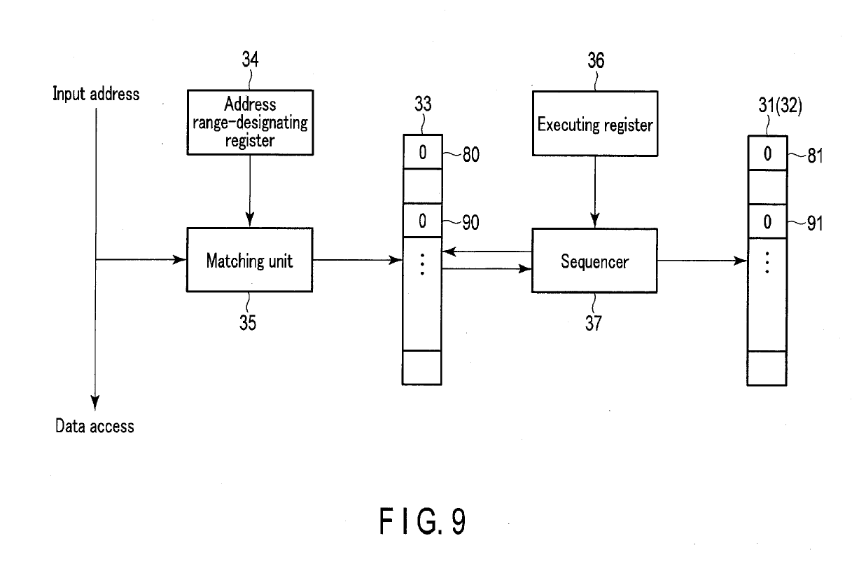

Likewise, the sequencer 37 reads out the set reserved bit (in this case, 60 shown in FIG. 8) from the RB data array 33. As shown in FIG. 9, the sequencer 37 clears the valid bit (VB) 91 of the cache line corresponding to the reserved bit in the VB data array 31 to “0”. After the process of invalidating the cache lines, the sequencer 37 clears the corresponding reserved bit (RB) 90 in the RB data array 33 to “0”.

In the state shown in FIG. 6, it is assumed that address (C) not matching the designated address range is input. This input address (C) is treated as an address stored in the same entry as the cache line corresponding to address (A) (i.e., addresses (A) and (C) have the same index part but different tag parts). By entering address (C), the cache line corresponding to input address (C) is loaded into the cache memory unit 11. In this case, the cache line corresponding to address (A) is purged from the cache memory unit 11.

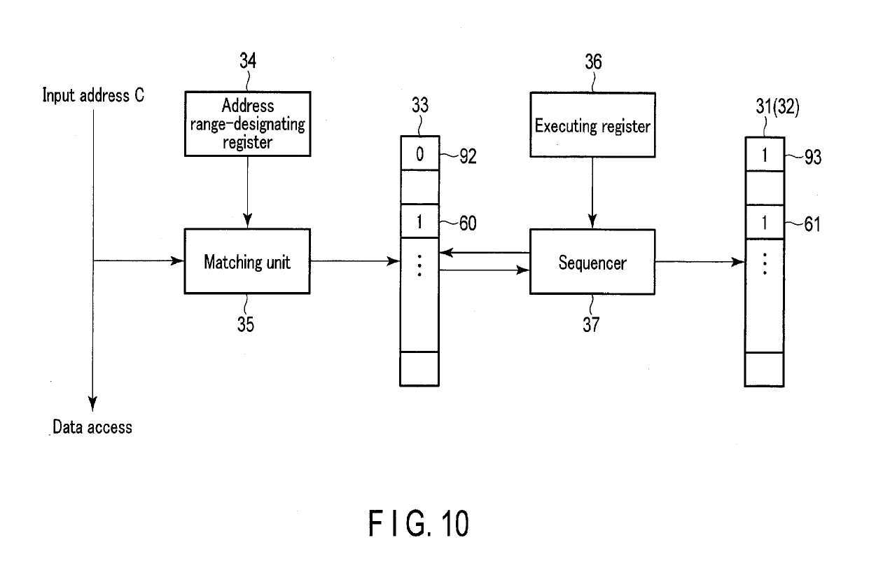

In this manner, as shown in FIG. 10, the valid bit (VB) 93 corresponding to the cache line corresponding to input address (C) in the VB data array 31 is set to “1”. Also, since input address (C) does not match the designated address range, the corresponding reserved bit (RB) 92 of the RB data array 33 is not set and thus remains “0”. Since the cache line corresponding to address (A) is purged from the cache memory 11, address (A) is to be invalidated. Therefore, the corresponding reserved bit (RB) 60 currently set to “1” will be cleared to “0”.

Further, the address range-designating register 34 is cleared, for example, after the process of accessing is completed by the CPU 10.

As described above, the embodiment can also be applied to the process of flushing. The process of flushing, as described above, means a process of invalidation and a process of write back. Thus, in the case of the process of flushing, the DB data array 32 is used in addition to the VB data array 31. In other words, upon executing the process of flushing, the dirty bit (DB) of “1” of the corresponding cache line is cleared to “0”.

As described above, according to the embodiment, by setting in the reserved bit data array (RB data array) the reserved bit corresponding to all cache lines within the designated address range, it is possible to execute the process of cache maintenance for all cache lines without having to read the tag addresses, and thus to execute the process at high speed. This is especially effective when the designated address range is wide.

According to the conventional process of cache maintenance, “address range (byte)/cache line size (byte)” times the data retrieval were necessary. In contrast to this, according to the embodiment, by retrieving the reserved bit corresponding to all cache lines, it is possible to reduce the time needed for executing the process of cache maintenance. Especially, due to configuring the RB data array of flip-flops, the process of cache maintenance can be speeded up since it is possible to execute the process in the designated address range in one cycle. Furthermore, since it is not necessary to read the tag addresses, it is possible to reduce the power consumption associated with the process of cache maintenance.

If the RB data array is configured of a SRAM, it takes the number of cycles equivalent to the number of SRAM entries, since the execution is sequential. However, if the number of cycles is smaller than the “address range (byte)/cache line size (byte)”, the execution time can likewise be shortened and the power consumption associated with the process of cache maintenance can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a cache memory; and
a cache controller, wherein the cache controller comprises:
a first circuit configured to store a designated address range for a process of cache maintenance;
a second circuit configured to determine whether or not the addresses to be accessed for the cache memory by the information processing apparatus are within the designated address range; and
a third circuit configured to store reservation information for reserving execution of a process of cache maintenance for cache lines corresponding to addresses within the designated address range.

2. The information processing apparatus of claim 1, wherein the cache controller further comprises a fourth circuit configured to execute the process of cache maintenance for cache lines indicated by the reservation information stored by the third circuit.

3. The information processing apparatus of claim 1, wherein the first circuit is configured to store the designated address range before the process of accessing is executed for the designated address range by the information processing apparatus.

4. The information processing apparatus of claim 2, wherein the fourth circuit is configured to execute the process of cache maintenance after the process of accessing is completed for the designated address range by the information processing apparatus.

5. The information processing apparatus of claim 4, wherein the fourth circuit comprises a register circuit for storing information prompting to execute the process of cache maintenance after the process of accessing is completed, and the fourth circuit is configured to execute the process of cache maintenance based on the information stored in the register circuit.

6. The information processing apparatus of claim 2, wherein:
the cache controller further comprises a fifth circuit configured to store validity information indicating, for each of the cache lines, validity of the cache lines; and
the fourth circuit is configured to clear the validity information corresponding to the cache lines indicated by the reservation information.

7. The information processing apparatus of claim 1, wherein the process of cache maintenance includes:
a process of invalidating the cache lines corresponding to the addresses; and
a process of flushing the cache lines corresponding to the addresses.

8. The information processing apparatus of claim 1, wherein the cache controller is configured to clear the reservation information corresponding to the reserved cache lines that are purged from the cache memory.

9. A cache control apparatus applied to an information processing apparatus including a cache memory, comprising:
a first circuit configured to store a designated address range for a process of cache maintenance;
a second circuit configured to determine whether or not the addresses to be accessed for the cache memory by the information processing apparatus are within the designated address range; and
a third circuit configured to store reservation information for reserving execution of a process of cache maintenance for cache lines corresponding to addresses within the designated address range.

10. The cache control apparatus of claim 9, further comprises a fourth circuit configured to execute the process of cache maintenance for cache lines indicated by the reservation information stored by the third circuit.

11. The cache control apparatus of claim 9, wherein the first circuit is configured to store the designated address range before the process of accessing is executed for the designated address range by the information processing apparatus.

12. The cache control apparatus of claim 10, wherein the fourth circuit is configured to execute the process of cache maintenance after the process of accessing is completed for the designated address range by the information processing apparatus.

13. The cache control apparatus of claim 12, wherein the fourth circuit comprises a register circuit for storing information prompting to execute the process of cache maintenance after the process of accessing is completed, and the fourth circuit is configured to execute the process of cache maintenance based on the information stored in the register circuit.

14. The cache control apparatus of claim 9, wherein the second circuit comprises a matching circuit configured to determine whether or not the addresses are within the designated address range.

15. The cache control apparatus of claim 10, further comprising a fifth circuit configured to store validity information indicating, for each of the cache lines, validity of the cache lines; and wherein the fourth circuit is configured to clear the validity information corresponding to the cache lines indicated by the reservation information.

16. The cache control apparatus of claim 9, wherein the process of cache maintenance includes:
a process of invalidating the cache lines corresponding to the addresses; and
a process of flushing the cache lines corresponding to the addresses.

17. A method of cache control applied to an information processing apparatus including a cache memory, the method comprising:
executing a first process for storing a designated address range for a process of cache maintenance;
executing a second process for determining whether or not the addresses to be accessed for the cache memory by the information processing apparatus are within the designated address range; and
executing a third process for staring reservation information for reserving execution of a process of cache maintenance for cache lines corresponding to addresses within the designated address range.

18. The method of claim 17, further comprises a fourth process for executing the process of cache maintenance for cache lines indicated by the reservation information stored by the third process.

19. The method of claim 17, wherein the first process stores the designated address range before the process of accessing is executed for the designated address range by the information processing apparatus.

20. The method of claim 18, wherein the fourth process executes the process of cache maintenance after the process of accessing is completed for the designated address range by the information processing apparatus.
